(19) United States
(12) Patent Application Publication
(10) Pub. No.: US 2020/0226554 A1
(43) Pub. Date: Jul. 16, 2020

(54) AUTOMATED SUGGESTIONS FOR TO-DO LIST REMINDERS VIA NATIVE NOTIFICATIONS

(71) Applicant: Microsoft Technology Licensing, LLC, Redmond, WA (US)

(72) Inventor: Alfredo Cerezo Luna, Berlin (DE)

(21) Appl. No.: 16/245,591

(22) Filed: Jan. 11, 2019

(51) Int. Cl. G06Q 10/10; G06F 9/54

(52) U.S. Cl. CPC G06Q 10/1097; G06F 9/542

(57) ABSTRACT

In non-limiting examples of the present disclosure, systems, methods and devices for surfacing reminders for task completion are provided. A plurality of tasks may be received. Each of the tasks may be associated with a due date. A notification may be surfaced, wherein the notification comprises: an indication that at least one of the plurality of tasks has not been completed, and an indication that at least one of the plurality of tasks has been completed. A selectable suggestion element for adding one or more incomplete tasks from the plurality of tasks to a to-do list for a current day may be surfaced. A selection of the selectable suggestion element may be received, and an incomplete task corresponding to the selectable suggestion element may be added to the to-do list for the current day.

### BACKGROUND

As computers have become ubiquitous in everyday life, so to has their use in making users' lives more productive. To-do lists are one of the key tools that experts identify as being integral in being productive and accomplishing goals. However, because to-do lists on computers are generally included at the application level of a device and applications can easily be forgotten behind application folders and/or pages of other application icons, users may forget and/or find it difficult to update their existing to-do lists, and create new to-do lists when tasks have been completed.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for generating automated reminders for surfacing via native notifications and assisting with daily to-do list creation. Users can select days and times that they will receive notifications on their devices to add incomplete tasks, including overdue and soon-to-be due tasks, to a current and/or next day to-do list. The notification may comprise and/or be interacted with for surfacing of the incomplete tasks in a selectable suggestion element. In examples, the notification and/or the suggestion element may also include a summary of one or more previously-completed tasks from a user's to-do list, thereby incentivizing the completion of additional tasks, and the adding of incomplete tasks to a current day's to-do list. In examples, the incomplete tasks that are surfaced in association with a notification may be identified by the to-do list application and/or a to-do list application service in an intelligent manner by identifying tasks that are relevant to a user based on a device type on which the notification is surfaced.

### BRIEF DESCRIPTION OF THE DRAWINGS

Non-limiting and non-exhaustive examples are described with reference to the following figures:

FIG. 1 is a schematic diagram illustrating an example distributed computing environment for generating automated reminders for surfacing via native notifications.

FIG. 2 is a schematic diagram illustrating an example suggestion selection flow environment on a mobile computing device for creating and/or augmenting a to-do list with reminders that have been surfaced via native notifications.

FIG. 3 illustrates the surfacing of reminder suggestions via native notifications on a laptop computing device for selective inclusion in a daily to-do list, where the suggestions correspond to the computing device that the suggestions are surfaced on.

FIG. 4 illustrates the surfacing of reminder suggestions via native notifications on a mobile computing device for selective inclusion in a daily to-do list, where the suggestions correspond to the computing device that the suggestions are surfaced on.

FIG. 5 is an exemplary method for surfacing reminders via native notifications.

FIGS. 6 and 7 are simplified diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Examples of the disclosure provide systems, methods, and devices for generating automated reminders for surfacing via native notifications and assisting with daily to-do list creation. In examples, a setting associated with a to-do list application may allow a user to select days of the week and times associated with selected days of the week when a notification will be surfaced on one or more of the user's computing devices. The notification may include, or be selectable to cause the surfacing of, one or more incomplete tasks from one or more to-do lists associated with the user. The notification may also include, or be selectable to cause the surfacing of, one or more tasks that the user has completed from one or more to-do lists associated with the user. Thus, if the user interacts with the setting and selects Mondays, Wednesdays and Fridays at 10 am for receiving the notification, a notification may be surfaced on one or more of the user's devices on Mondays, Wednesdays and Fridays at 10 am. The notification may include the one or more incomplete tasks or the user may have to interact with the notification to have a task suggestion list surfaced on the user's device. For example, if the notification is surfaced by the to-do list application, the user may touch the notification, unlock the device, etc., and based on that interaction, a task suggestion list including one or more incomplete tasks and/or completed tasks from the user's to-do lists may be surfaced for selection and adding of one or more of the incomplete tasks to a current and/or next day's to-do list. In some examples, each selected task from the suggestion list may be added to the current day's to-do list regardless of what time the user selects the task. In other examples, each selected task from the suggestion list may be added to the current day's to-do list if the selection is made prior to a specified time of day (e.g., before 5 pm), while each selected task from the suggestion list may be added to the next day's to-do list if the selection is made after a specified time of day (e.g., after 5 pm).

In some examples, the incomplete tasks that are surfaced with, or in association with, the notification and/or suggestion list may be surfaced at least in part based on most “overdue” tasks from a user's to-do lists and/or tasks that are closest in time to being due. Additionally or alternatively, the incomplete tasks that are surfaced with, or in association with, the notification and/or the suggestion list may be surfaced at least in part based on a device type on which the corresponding notification is received. The device types may comprise, for example: work device type, home device type, personal device type, mobile device type, etc. In some examples, if the notification is surfaced on a work device, the incomplete tasks surfaced in association with the notification may comprise work-related tasks (e.g., tasks that have been added to a user's “work” task list; tasks that have been automatically categorized as relating to work). In additional examples, if the notification is surfaced on a mobile device, the incomplete tasks surfaced in association with the notification may comprise tasks that are determined to need to be completed while a user is away from home or work, or the incomplete tasks surfaced in association with the notification may correspond to a current location of the mobile device (e.g., if a user is close to a grocery store a “pickup groceries” task may be added to the user's current day list; if a user is close to a dry cleaner a “drop-off dry cleaning” task may be added to the user's current day list). In additional examples, if the notification is surfaced on a personal device, the incomplete tasks surfaced in association with the notification may comprise tasks that do not relate to work.

In some examples, the completed tasks that are surfaced in association with the notification and/or task suggestion list may be based on most recently completed tasks from a user's to-do lists. In other examples, the completed tasks that are surfaced may be based on previously surfaced completed tasks or task types which have prompted a user to complete a highest number of tasks from a current day's to-do list in the past. In other examples, the tasks that are surfaced may be ranked in an order or prominence in the task suggestion list according to one or more of those criteria.

The systems, methods, and devices described herein provide technical advantages for cross-device task completion. Rather than a user having to manually navigate to to-do lists and manually select tasks from those lists for adding to a current day's to-do list, the systems, methods and devices described herein allow for automatic selection of relevant tasks that are likely to be completed by a user on a current day, thereby reducing computer processing costs associated with the manual navigation and selection of those tasks. Processing costs are also reduced by surfacing tasks for adding to a current day based on a type of device that a notification is surfaced on and/or a location of a device that a notification is surfaced on, thereby encouraging completion of tasks that can most readily be accomplished at a device that a user is currently using and/or location that a user is currently at. In some examples, a current day to-do list propagated by the mechanisms described herein may provide memory savings in that a single current day to-do list may not need to be replicated in total across each of a user's devices. Rather multiple current day to-do lists that each differ based on a device type may be saved, thereby decreasing a size of each list on each device (e.g., a first, work type device, may have a current day to-do list that only includes work-related tasks; a second, personal type device, may have a current day to-do list that only includes home-related tasks).

Efficiency and user experience are also improved upon by the examples described herein. For example, users often have a difficult time reminding themselves to revisit tasks that have been added to various to-do lists, and the current examples provide mechanisms for automatically prompting users to re-surfacing relevant tasks via a current and/or next day task list. The mechanisms described herein also incentivize users to complete tasks by surfacing summaries and/or examples of tasks that they have previously completed, thereby further increasing the likelihood that users will complete past and/or soon to be due tasks via positive reinforcement of past accomplishments.

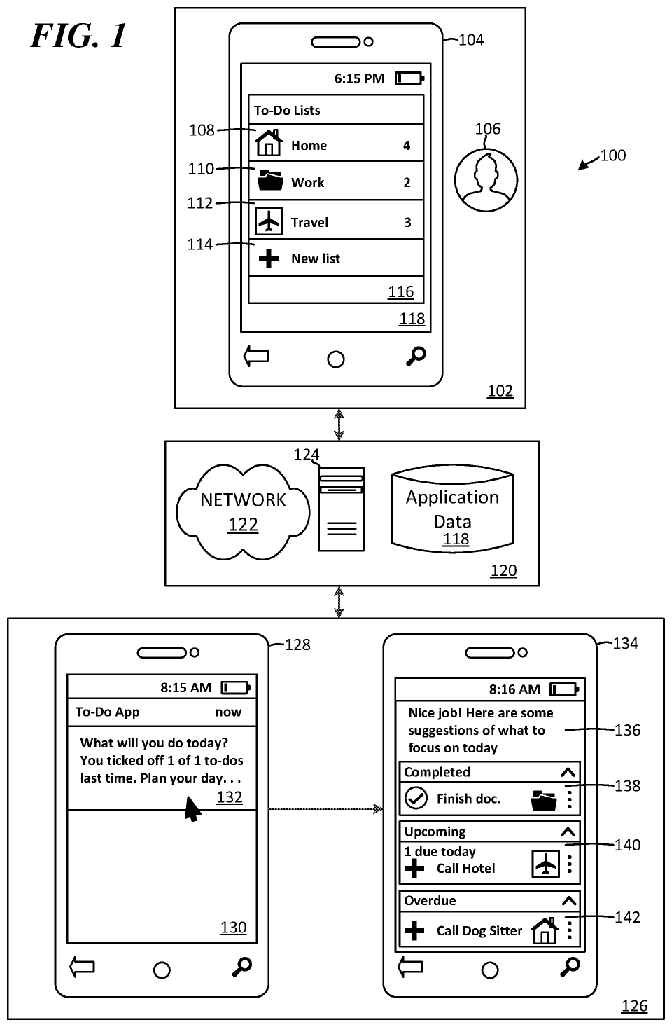

FIG. 1 is a schematic diagram illustrating an example distributed computing environment 100 for generating automated reminders for surfacing via native notifications. Computing environment 100 includes joint to-do list sub-environment 102, network and processing sub-environment 120, and reminder surfacing sub-environment 126. Joint to-do list environment 102 includes mobile computing device 104, which is associated with user 106, and reminder surfacing sub-environment 126 includes mobile computing device 128 and mobile computing device 134. Each of mobile computing devices 104, 128 and 134 may be the same or different computing devices. For example, computing device 104 may be user 106's mobile computing device at a first time (e.g., 6:15 pm), computing device 128 may be user 106's mobile computing device at a second time (e.g., 8:15 am), and computing device 134 may be user 106's mobile computing device at a third time (e.g., 8:16 am). However, while in some examples computing devices 104, 128 and 134 may comprise the same device (e.g., a same smart phone), in other examples, computing devices 104, 128 and 134 may comprise different devices (e.g., computing devices 104 and 128 may comprise a same smart phone associated with user 106, and computing device 134 may comprise a tablet associated with user 106).

A user interface 118 for a to-do list application is displayed on computing device 104. User interface 118 displays to-do list overview pane 116, which includes a plurality of to-do lists that user 106 has created using the to-do list application, as well as a selectable option 114 to create a new to-do list. The to-do lists that user 106 has created are “Home” to-do list 108 that is displayed in association with a home icon, “Work” to-do list 110 that is displayed in association with a folder icon, and “Travel” to-do list 112 that is displayed in association with an airplane icon.

According to examples, user 106 may utilize a reminder setting associated with the to-do list application. The user may select one or more times and/or days of a week that reminders may be surfaced on one or more of the user's devices, via native notifications of the devices, for creating a new to-do list and/or augmenting an existing to-do list. A user may select individual days of a week that reminders should be surfaced and/or the user may utilize a one-touch interaction to select all business days (Monday-Friday) and/or all weekend days (Saturday-Sunday) for surfacing the reminders. In some examples, when the user sets the reminders via the reminder settings, the to-do list application may also surface a summary of one or more tasks that have been completed from the user's to-do lists to further incentivize the user to use the to-do list application and create daily reminders.

In some examples, the to-do list application may be executed, at least in part, in the cloud on one or more computing devices, such as server computing device 124 in network and processing sub-environment 120. For example, user 106 may interact with the user interface displayed on computing device 104, that interaction may be communicated to the cloud-based to-do list application service via network 122 for processing of one or more commands associated with the interaction, and the user interface may be modified based on a communication from the cloud-based to-do list application service to computing device 104. In some examples, application data associated with one or more users of the to-do list application may be stored in the cloud in an application data store, such as application data store 118. The application data may comprise data associated with the to-do list application and/or data associated with one or more applications that a user of the to-do list application has granted the to-do list application access to. For example, a user may specifically grant the to-do list application with access to information associated with a calendar application, an electronic messaging application, a word processing application, a presentation application, and/or other productivity applications. In some examples the to-do list application may utilize data from one or more other applications to intelligently generate reminders, to-do lists, and/or schedule reminders and due dates/times.

In this example, user 106 has utilized the reminder setting of the to-do list application to cause the to-do list application to surface reminders for creation of new to-do lists, and/or augmentation of existing to-do lists, at 8:15 am on one or more days of the week. As such, when computing device determines that it is 8:15 am on one of the days of the week that user 106 has selected, the to-do list application operating on computing device 128 and/or on one or more computing devices in network and processing sub-environment 120 causes a notification that is native to computing device 128 to be surfaced on the display 130 of computing device 128. In this example, that notification is notification 132, which includes a selectable message that user 106 may select to initiate display of one or more not yet completed to-dos from one or more of user 106's to-do lists (e.g., home to-do list 108, work to-do list 110, travel to-do list 112) that can be added to a new or existing to-do list for a current day and/or a next day, and in some examples, one or more to-dos that have been identified by the to-do list application as having been completed by user 106. In this example, notification 132 includes partial message: “What will you do today? You ticked off 1 of 1 to-dos last time. Plan your day . . . .” Regardless of the text included in the message, user 106 may select notification 132, which causes computing device 128 to automatically open the to-do list application, and surface one or more suggested tasks from one or more of user 106's to-do lists for adding to a current and/or next day, and one or more completed tasks from user 106's to-do lists. This is illustrated on the user interface of computing device 134.

Computing device 134, upon selection of notification 132, opens the to-do list application, and displays a message 136 indicating to user 106 that the user can select one or more suggested to-dos from one or more of the user's to-do lists for adding to a to-do list for a current and/or next day. In this example, that message states: “Nice job! Here are some suggestions of what to focus on today[.]” A first selectable user interface element 142 is caused to be displayed on computing device 134, based on selection of notification 132, which corresponds to a first suggested to-do list task from user 106's home to-do list 108, which user 106 may select to cause that to-do list task to be added to a current and/or next day's to-do list. A second selectable user interface element 140 is also caused to be displayed on computing device 132, based on selection of notification 132, which corresponds to a second suggested to-do list task from user 106's travel to-do list 112, which user 106 may select to cause that to-do list task to be added to a current and/or next day's to-do list. Additionally, a first completed task user interface element 138 is also caused to be displayed on computing device 132, based on selection of notification 132, which corresponds to a first completed task from one of user 106's to-do lists. In some examples, more or less suggested to-dos and/or completed to-dos may be caused to be displayed on computing device 134 in response to user 106's selection of notification 132. For example, there may be additional suggested to-dos which user 106 may cause to be displayed on the display of computing device 134 by scrolling down on the display of computing device 134, deleting one or more displayed suggested to-dos and/or displayed completed to-dos, and or when user 106 adds one or more of the displayed suggested to-dos to a current and/or next day's to-do list.

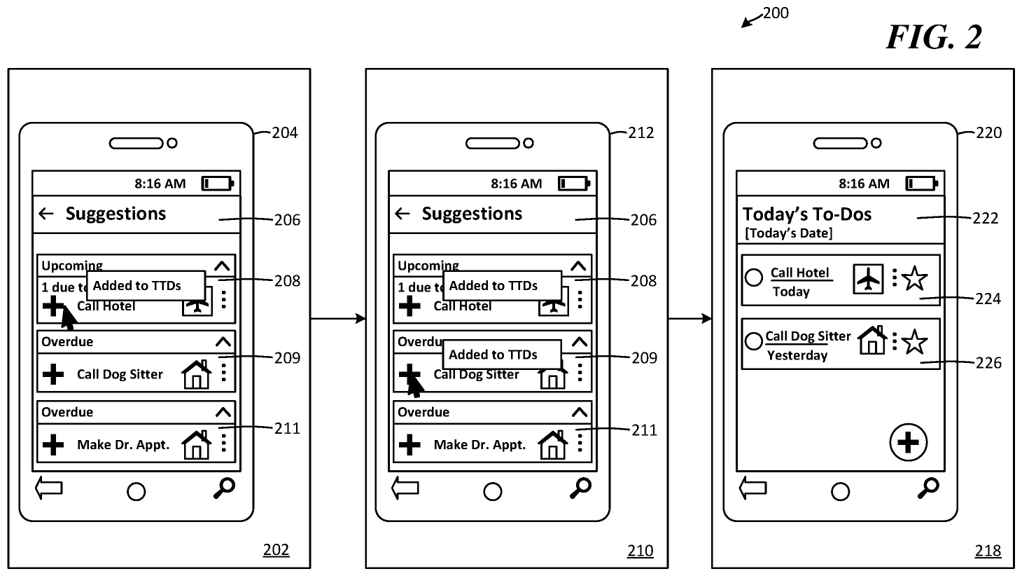

FIG. 2 is a schematic diagram illustrating an example task suggestion selection flow environment 200 on a mobile computing device for creating and/or augmenting a to-do list with reminders that have been surfaced via native notifications. Task selection flow environment 200 includes first task suggestion selection sub-environment 202, second task suggestion selection sub-environment 210, and current day's to-do list sub-environment 218.

Although not shown, a user associated with a to-do list application has utilized a reminder setting of the to-do list application to select one or more days of the week and times associated with those selected one or more days of the week to have the to-do list application surface suggested tasks (“to-dos”) from one or more of the user's to-do lists that may be selectably added to a current or next day's to-do list. According to some examples, the to-do list application and/or a to-do list service associated with the to-do list application may identify to-dos for suggesting to a user based on which to-dos in the user's to-do lists are the most overdue and/or which to-dos in the user's to-do lists have a closest due date. Additionally or alternatively, the to-do list application and/or a to-do list service associated with the to-do list application may identify to-dos for suggesting to a user based on a device that the suggestions are surfaced on and/or a device that the user is currently using. For example, if a user has the to-do list application installed on a desktop computing device and a smart phone, a first set of suggested to-dos may be surfaced on the desktop computing device that are identified from a work-related to-do list, and a second set of suggested to-dos may be surfaced on the smart phone that are identified from one or more “personal” to-do lists and/or that are identified based on relating to tasks that need to be accomplished away from home or work (e.g., “buy groceries”, “tennis lesson”, etc.). In examples where the to-do list application and/or the to-do list service has identified that a specific computing device is currently being utilized by the user, the to-do list application and/or service may only cause to-do list task suggestions and/or a corresponding notification to be displayed on that device, as opposed to surfacing the to-do list task suggestions and/or a corresponding notification on each of the user's devices.

In the illustrated example, the user has selected 8:15 am on one or more days of the week to have a notification surfaced by the to-do list application for adding suggested to-do list tasks to a current and/or next day's to do list. Although not shown, a native notification is caused to be surfaced on the user's computing device at 8:15 am for adding suggested to-do list tasks to a current and/or next day's to do list, and the user has selected that notification. Based on selection of that notification, the computing device on which the selection was made displays suggested to-do list tasks from the user's to do lists for adding to a current and/or next day's to do list. In this example, this is illustrated by the suggestion task list 206 on computing device 204 in first task suggestion selection sub-environment 202. The suggestion task list 206 includes a first selectable user interface icon 208, which is selectable for adding a “Call Hotel” task from the user's travel to-do list to a current and/or next day's to-do list; a second selectable user interface icon 209, which is selectable for adding a “Call Dog Sitter” task from the user's home to-do list to a current and/or next day's to-do list; and a third selectable icon 211, which is selectable for adding a “Make Dr. Appt.” task from the user's home to-do list to a current and/or next day's to-do list.

In this example, the user interacts (e.g., via a touch interaction, a mouse click interaction, etc.) with first selectable user interface icon 208, and the to-do list application is thereby caused to add the “Call Hotel” task from the user's travel to-do list to a current and/or next day's to-do list. For example, if a user does not currently have a to-do list for the current day, a new “current day” to-do list may be created that includes the “Call Hotel” task. Alternatively, if the user already has a to-do list for the current day with to-dos associated with it, the “Call Hotel” task may be added to the existing “current day” to-do list tasks. In some examples, when the user adds a suggested task from the suggestion task list 206 to a current and/or next day's to-do list, a pop-up window or other display indicator may indicate that the selected task has so been added. For example, as shown on the display of computing device 204, a pop-up window indicating that the user has added the “Call Hotel” task to the current day's to-do list (“Today's To-Dos” “TTD”) is caused to be surfaced on the task application user interface on computing device 204.

As illustrated in second task suggestion selection sub-environment 210, after adding the “Call Hotel” task corresponding to first selectable user interface icon 208 to a current day's to-do list, the user then interacts with second selectable user interface icon 209, and the to-do list application is thereby caused to add the “Call Dog Sitter” task from the user's home to-do list to the current day's to-do list. As with the selection of first selectable user interface icon 208, a pop-up window or other display indicator may be caused to be displayed for indicating that the selected task has been added to the current day's to-do list. For example, as shown on the display of computing device 212, a pop-up window indicating that the user has added the “Call Dog Sitter” task to the current day's to-do list is caused to be surfaced on the task application user interface on computing device 212.

The current day's to-do list 222 (“Today's To-Dos”) is displayed on the to-do list application user interface displayed on computing device 220 in current day's to-do list sub-environment 218. As illustrated, “Call Hotel” task 224 has been added to the user's current day's to-do list 222 based on the user's selection of that task in first task suggestion selection sub-environment 202, and “Call Dog Sitter” task 226 has been added to the user's current day's to-do list 222 based on the user's selection of that task in second task suggestion selection sub-environment 210.

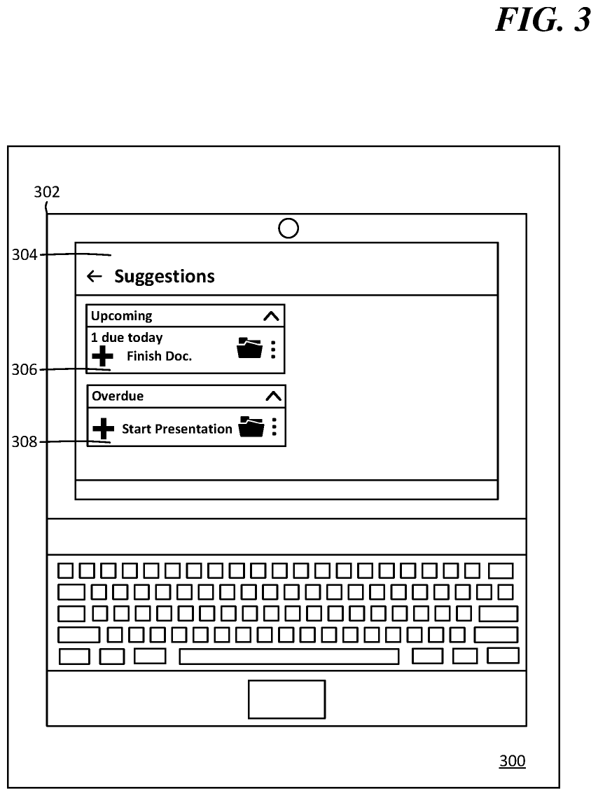

FIG. 3 illustrates the surfacing of reminder suggestions via native notifications on a laptop computing device 302 for selective inclusion in a daily to-do list, where the suggestions correspond to the computing device that the suggestions are surfaced on. Laptop computing device 302 in environment 300 is a work computer that a user associated with the to-do list application utilizes. In some examples, the user may specifically designate laptop computing device 302 as a work computer with the to-do list application and/or service. In other examples, the to-do list application and/or service may make a determination that laptop computing device 302 is a work computer based on analysis of one or more signals. The one or more signals may include or more of: a location of the laptop computing device (e.g., one or more locations where the laptop computing device spends a threshold duration of time); and/or application signals associated with one or more other applications installed and/or accessed on laptop computing device 302 (e.g., work email signals from an email application, work document creation signals from a word processing application).

Although not shown, a user associated with a to-do list application has utilized a reminder setting of the to-do list application to select one or more days of the week and times associated with those selected one or more days of the week to have the to-do list application surface suggested tasks from one or more of the user's to-do lists that may be selectably added to a current or next day's to-do list. When that time has been reached on one of the days of the week, a selectable native notification is caused to be displayed on laptop computing device 302, which is selectable for viewing task suggestions for adding to a current and/or next day's to-do list.

In this example, based on selection of the notification, the to-do list application and/or service causes task suggestions from the user's “work” to-do list to be surfaced in suggestion task list 304 on laptop computing device 302. Thus, in this example, first selectable user interface element 306, which may be selected for adding a “Finish Doc.” task from the user's work to-do list is surfaced in suggestion task list 304 on laptop computing device 302; and second selectable user interface element 308, which may be selected for adding a “Start Presentation” task from the user's work to-do list is also surfaced in suggestion task list 304 on laptop computing device 302.

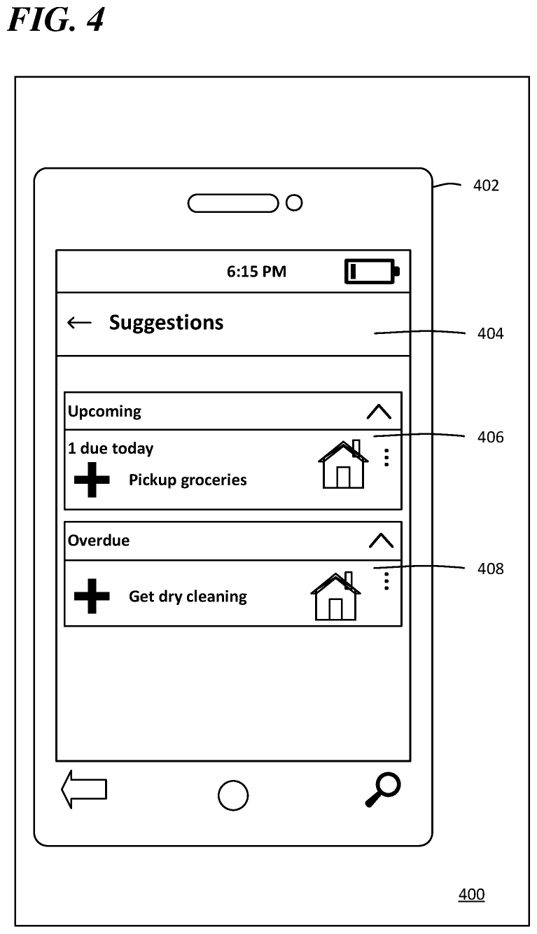

FIG. 4 illustrates the surfacing of reminder suggestions via native notifications on a mobile computing device 402 for selective inclusion of tasks in a daily to-do list, where the suggestions correspond to the computing device that the suggestions are surfaced on. Mobile computing device 402 in environment 400 may be a personal or work related mobile computing device, such as a smart phone or tablet. The to-do list application and/or service may identify mobile computing device 402 as a mobile device based on specifications of the device when the to-do list application is installed on the mobile computing device, for example.

Although not shown, a user associated with a to-do list application has utilized a reminder setting of the to-do list application to select one or more days of the week and times associated with those selected one or more days of the week to have the to-do list application surface suggested tasks from one or more of the user's to do lists that may be selectably added to a current or next day's to-do list. When that time has been reached on one of the days of the week, a selectable native notification is caused to be displayed on mobile computing device 402, which is selectable for viewing task suggestions for adding to a current and/or next day's to-do list.

In this example, based on selection of the notification, the to-do list application and/or service causes task suggestions that need to be completed away from a user's work and/or home location to be surfaced on suggestion task list 404 on mobile computing device 402. Thus, in this example, first selectable user interface element 406, which may be selected for adding a “Pickup groceries” task from the user's home to-do list is surfaced in suggestion task list 404 on mobile computing device 402; and second selectable user interface element 408, which may be selected for adding a “Get dry cleaning” task from the user's home to-do list is also surfaced in suggestion task list 404 on mobile computing device 402.

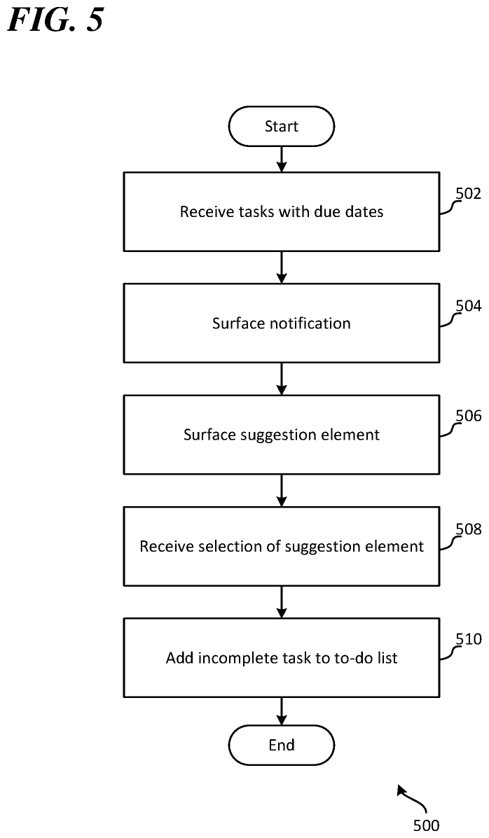

FIG. 5 is an exemplary method 500 for surfacing reminders via native notifications. The method 500 begins at a start operation and flow continues to operation 502.

At operation 502 a plurality of tasks are received by a to-do list application. In some examples the to-do list application may operate entirely on a single device on which the tasks are received and the application is installed. In other examples, the to-do list application may operate all or in part in the cloud in association with a to-do list application service. Thus, in some examples, the plurality of tasks may be received by one or more server computing devices as part of a cloud-based to-do list application service. Each of the plurality of tasks may be associated with a due date. For example, a user may create and name a first to-do list “home” and a second to-do list “work” in the to-do list application, and add one or more tasks to each of the to-do lists (e.g., “buy groceries” and “call doctor” in the “home” to-do list; “finish project A” and “send reports” in the “work” to-do list). At the same or a different time that the tasks are added to a to-do list, the user may associate those tasks with a due date (e.g., “buy groceries”—due date “December 13”, “finish project A”—due date “January 17”).

From operation 502 flow continues to operation 504 where a notification is surfaced on a device associated with a to-do list application. The notification may comprise an indication of at least one of the plurality of tasks that has not been completed, and an indication of at least one of the plurality of tasks that has been completed. In some examples, the notification may provide the indication of the incomplete tasks and the completed tasks when the user interacts with the notification. In additional examples, the incomplete tasks that are surfaced with the notification may be tasks that are included in one or more to-do lists that the user has created. In other examples, the incomplete tasks that are surfaced with the notification may be tasks that are automatically generated based on application of one or more machine learning models to one or more signals received from one or more other applications (e.g., extracting a task and due date from an email received from an email application; extracting a task and due date from a message in an instant messaging application, extracting a task and due date from a calendar application entry etc.). In some examples, the incomplete tasks that are surfaced with the notification may be identified for surfacing on a device based on the device type and/or device location on which the notification is surfaced. For example, if the notification is surfaced on a mobile computing device, the notification may comprise incomplete tasks that need to be completed away from the home or office. In another example, if the notification is surfaced on a work computer, the notification may comprise incomplete tasks from a work to-do list. In still other examples, if the notification is surfaced on a device that is located at the user's home, the notification may comprise incomplete tasks that are not work related and that do not need to be completed away from home or work (e.g., book travel reservations, make appointments, etc.). According to additional examples, completed tasks that are surfaced with the notification may be the most recently completed tasks from a user's to-do list. In other examples, the completed tasks that are surfaced with the notification may be based on the device on which the notification is surfaced (e.g., surface completed work-related tasks on work-devices, surface completed personal-related tasks on personal devices).

The notification may be surfaced based on a user interacting with a to-do list application reminder setting that triggers the notification on selected days of the week at one or more selected times. For example, a user may interact with the setting and create a rule that the notification be surfaced on one or more of the user's devices on certain days of the week, and at certain times. In some examples, the user may use a one-touch input to select all work days (i.e., Monday-Friday) and/or all weekend days (i.e., Saturday-Sunday). When the selected notification time occurs on a selected day, the notification is automatically surfaced on one or more of the user's devices. The notification may comprise a native notification based on a device type and/or operating system of each device.

From operation 504 flow continues to operation 506 where a selectable suggestion element for adding one or more incomplete tasks from the plurality of tasks to a to-do list for a current day is surfaced on the computing device associated with the to-do list application. In examples, the selectable suggestion element is surfaced in response to receiving a user interaction with the surfaced notification, and/or in response to a user unlocking the device on which the notification has been surfaced. In other examples, the selectable suggestion element may be surfaced on a device lock screen in association with the surfaced notification. In some examples, the one or more incomplete tasks that may be added to a to-do list for the current day may be one or more of the same tasks as were surfaced with the notification. In additional examples, the one or more incomplete tasks that may be added to a to-do list for the current day may include additional tasks that were not included with the notification. The incomplete tasks included in the suggestion element may be included based on tasks that the user has previously completed. For example, if a user has shown consistency completing one or more work-related tasks, the suggestions may include similar work-related tasks in the suggestion element. Alternatively and in other examples, if the user has incomplete tasks that are infrequently completed, those tasks may be surfaced more prominently (e.g., more often, higher in an ordered list, etc.) in the suggestion element.

In some examples, rather than providing the ability to add the incomplete tasks to a to-do list for a current day, the incomplete tasks may be added to a to-do list for a next day. For example, if the notification is received at a specified time that is later in the day (e.g., after 5 pm, after 8 pm), the incomplete tasks in the suggestion element may be interacted with such that they are added to a to-do list for the next day rather than the current day. In some examples, this may be performed automatically by the to-do list application based on an application setting (e.g., all notification interactions after a certain time relate to a next day to-do list).

From operation 506 flow continues to operation 508 where a selection of the selectable suggestion element is received. For example, the user may select one or more of the incomplete tasks from the suggestion element for adding to the current or next day to-do list. In some examples, the selected incomplete tasks may be automatically categorized in the current or next day to-do list based on the original to-do list that they were associated with. In other examples, the selected incomplete tasks may be recategorized as relating to the current or next day to-do list. In still other examples, the user may manually recategorize the selected incomplete tasks into one or more to-do list categorizations.

From operation 508 flow continues to operation 510 where an incomplete task corresponding to the selectable suggestion element is added to the to-do list for the current day. Thus, each of the selected incomplete tasks that the user has selected form the selectable suggestion element are added to a surfacable to-do list for the current day such that a user may have those tasks presented more prominently to the user than those tasks would otherwise be in their previous to-do list classifications.

From operation 510 flow continues to an end operation and the method 500 ends.

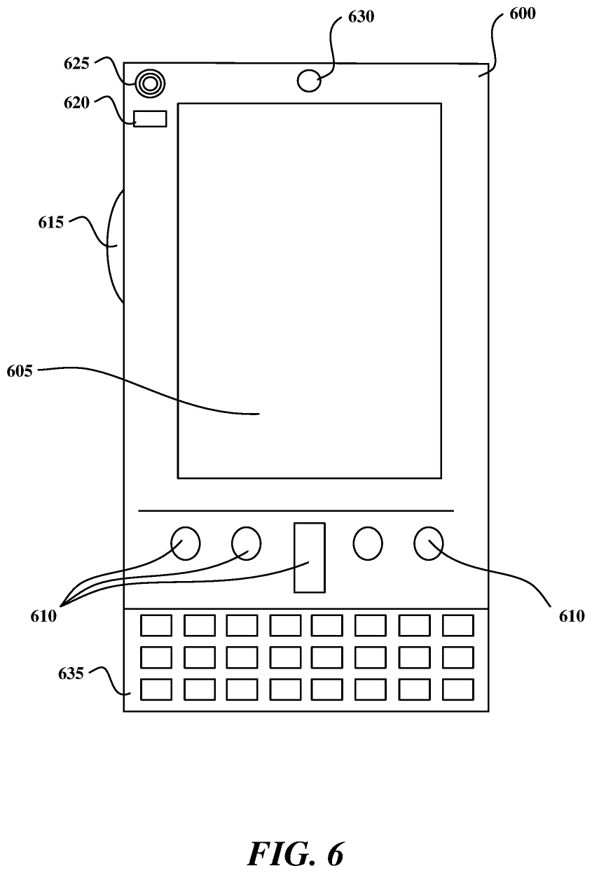

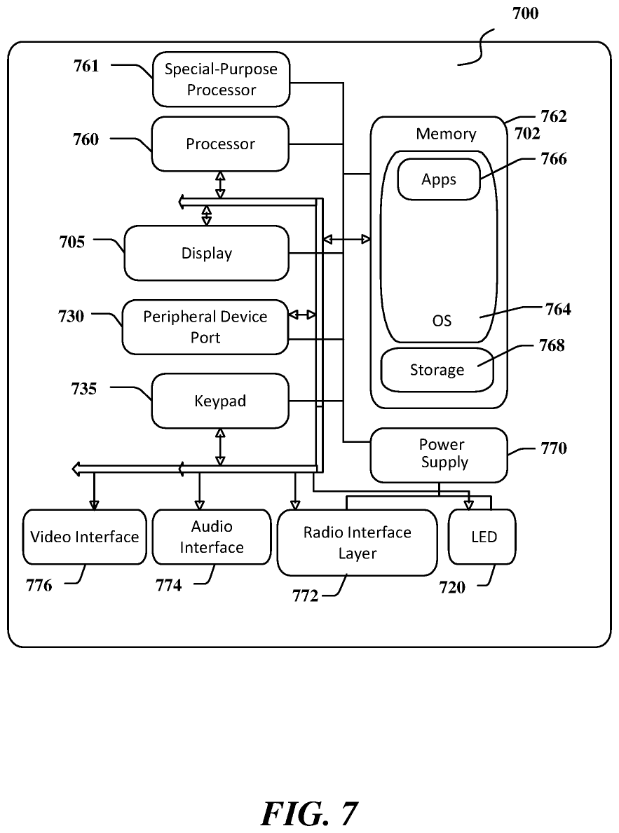

FIGS. 6 and 7 illustrate a mobile computing device 600, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or fewer input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 864. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including instructions for providing and operating a to-do list application and/or a daily to-do list creation and/or augmentation service.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

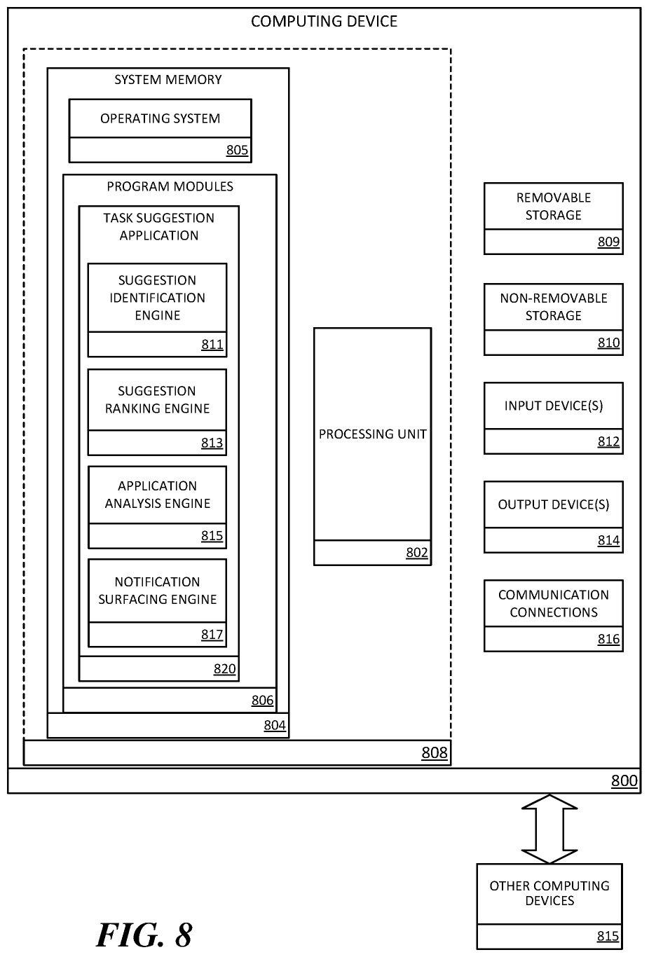

FIG. 8 is a block diagram illustrating physical components (e.g., hardware) of a computing device 800 with which aspects of the disclosure may be practiced. The computing device components described below may have computer executable instructions for assisting with daily to-do list task propagation and creation. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more to-do list programs. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., task suggestion application 820) may perform processes including, but not limited to, the aspects, as described herein. According to examples, suggestion identification engine 811 may perform one or more operations associated with identifying relevant incomplete tasks for surfacing with or in association with native notifications on computing devices. Suggestion ranking engine 813 may perform one or more operations associated with ranking tasks for presentation in a selectable task suggestion list. Application analysis engine 815 may perform one or more operations associated with analyzing one or more signals from one or more productivity applications for determining tasks to populate to-do lists with. Notification surfacing engine 817 may perform one or more operations associated with surfacing native to-do list notifications on user devices based on device type.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

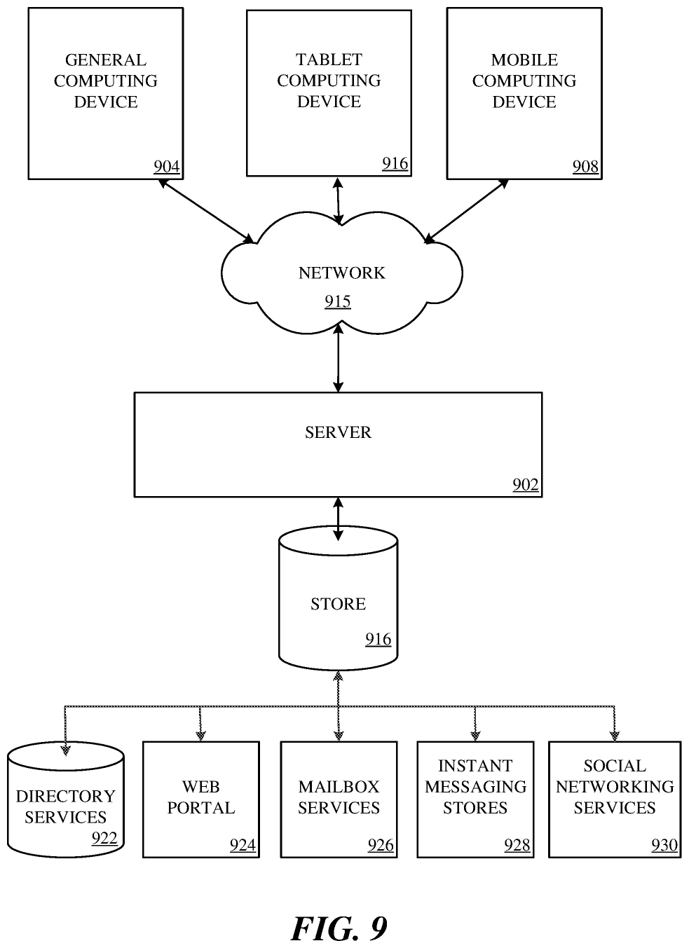

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-8 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for surfacing reminders, the method comprising:
receiving a plurality of tasks, each of the plurality of tasks received with an associated due date;
surfacing a notification, wherein the notification comprises:
an indication that at least one of the plurality of tasks has not been completed, and
an indication that at least one of the plurality of tasks has been completed;
surfacing, in association with the notification, a selectable suggestion element for adding one or more incomplete tasks from the plurality of tasks to a to-do list for a current day;
receiving a selection of the selectable suggestion element; and
adding an incomplete task corresponding to the selectable suggestion element to the to-do list for the current day.

2. The method of claim 1, further comprising:
receiving a selection of one or more days of a week and a time associated with the one or more days of the week that a user would like to receive to-do list reminders on; and
surfacing the notification in response to the time being reached on one of the one or more days of the week.

3. The method of claim 2, wherein a plurality of the one or more days of the week that the user would like to receive to-do list reminders on are selectable via: a single-input selection of a weekend element corresponding to Saturday and Sunday; and a single-input selection of a weekday element corresponding to Monday, Tuesday, Wednesday, Thursday, and Friday.

4. The method of claim 1, wherein the one or more tasks that may be added to the to-do list for the current day based on selection of the selectable suggestion element are selected based on a device on which the notification is surfaced.

5. The method of claim 1, wherein the to-do list for the current day is a new to-do list, and wherein the incomplete task corresponding to the selectable suggestion element is a first task added to the new to-do list.

6. The method of claim 1, wherein the to-do list for the current day is an existing to-do list, and wherein the incomplete task corresponding to the selectable suggestion element is not a first task added to the existing to-do list.

7. The method of claim 1, wherein the notification comprises a comparison of a number of the plurality of tasks that have not been completed, with a number of the plurality of tasks that have been completed.

8. The method of claim 1, wherein the one or more tasks that may be added to the to-do list for the current day based on selection of the selectable suggestion element are identified based on crawling one or more productivity applications for task-related events.

9. A system for surfacing reminders, comprising:
a memory for storing executable program code; and
one or more processors, functionally coupled to the memory, the one or more processors being responsive to computer-executable instructions contained in the program code and operative to:
receive a plurality of tasks, each of the plurality of tasks received with an associated due date;
surface a notification, wherein the notification comprises:
an indication that at least one of the plurality of tasks has not been completed; and
an indication that at least one of the tasks has been completed;
surface, in association with the notification, a selectable suggestion element for adding one or more incomplete tasks from the plurality of tasks to a new to-do list;
receive a selection of the selectable suggestion element; and
add an incomplete task corresponding to the selectable suggestion element to the new to-do list.

10. The system of claim 9, wherein the one or more processors are further responsive to the computer-executable instructions contained in the program code and operative to:
receive a selection of one or more days of a week and a time associated with the one or more days of the week that a user would like to receive to-do list reminders on; and
surface the notification in response to the time being reached on one of the one or more days of the week.

11. The system of claim 10, wherein a plurality of the one or more days of the week that the user would like to receive to-do list reminders on are selectable via: a single-input selection of a weekend element corresponding to Saturday and Sunday; and a single-input selection of a weekday element corresponding to Monday, Tuesday, Wednesday, Thursday, and Friday.

12. The system of claim 9, wherein the one or more tasks that may be added to the new to-do list based on selection of the selectable suggestion element are selected based on a device type of a device on which the notification is surfaced.

13. The system of claim 12, wherein the device type comprises one of: a mobile computing device, a desktop computing device, a personal computing device, and a work computing device.

14. The system of claim 9, wherein the one or more tasks that may be added to the new to-do list based on selection of the selectable suggestion element are identified based on crawling one or more productivity applications for task-related events.

15. A computer-readable storage device comprising executable instructions that, when executed by one or more processors, assists with surfacing reminders, the computer-readable storage device including instructions executable by the one or more processors for:
identifying a plurality of tasks, each of the identified tasks having an associated due date;
surfacing a notification comprising:
an indication that at least one of the identified tasks has not been completed, and
an indication that at least one of the identified tasks has been completed;
surfacing, in association with the notification, a selectable suggestion element for adding one or more incomplete tasks from the identified tasks to a to-do list;
receiving a selection of the selectable suggestion element; and
adding an incomplete task corresponding to the selectable suggestion element to the to-do list.

16. The computer-readable storage device of claim 15, wherein the plurality of tasks are identified from a previously created to-do list.

17. The computer-readable storage device of claim 15, wherein the one or more tasks that may be added to the to-do list based on selection of the selectable suggestion element are identified based on a device type of a device on which the notification is surfaced.

18. The computer-readable storage device of claim 17, wherein the device type comprises one of: a mobile computing device, a desktop computing device, a personal computing device, and a work computing device.

19. The computer-readable storage device of claim 15, wherein the one or more tasks that may be added to the to-do list based on selection of the selectable suggestion element are identified based on being of a specific task type.

20. The computer-readable storage device of claim 19, wherein the specific task type comprises one of: a most frequently completed task type, a least frequently completed task type, an urgent task type, a work task type, and a personal task type.
